(19) United States
(12) Patent Application Publication
(10) Pub. No.: US 2013/0321865 A1
(43) Pub. Date: Dec. 5, 2013

(54) PRINTING APPARATUS, METHOD FOR CONTROLLING PRINTING APPARATUS, AND STORAGE MEDIUM

(71) Applicant: CANON KABUSHIKI KAISHA, Tokyo (JP)

(72) Inventor: Yukiyoshi Hikichi, Tokyo (JP)

(21) Appl. No.: 13/904,638

(22) Filed: May 29, 2013

(30) Foreign Application Priority Data
May 31, 2012 (JP) 2012-124903

(51) Int. Cl. G06K 15/00

(52) U.S. Cl. CPC G06K 15/4065
USPC 358/1.15

(57) ABSTRACT

When a type of a sheet is changed and sheets are exchanged, an accurate number of sheet packages to be opened is notified to a user. A method for controlling a printing apparatus includes receiving a type of a sheet stored in a sheet storage unit, determining a number of sheet packages to be replenished in the sheet storage unit according to the received type of the sheet in a case where the received type of the sheet is different from a type of a sheet already stored in the sheet storage unit, and displaying the determined number of sheet packages.

### BACKGROUND OF THE INVENTION

1. Field of the Invention

The present disclosure generally relates to printing and, more particularly, to a printing apparatus, a method for controlling the printing apparatus, and a storage medium.

2. Description of the Related Art

In a printing apparatus such as a copy machine, products including a sheet storage unit for consecutively outputting a large amount of print products have increased. Sheets (printing sheet, cut sheet) to be inserted into the sheet storage unit are generally packaged by the 500 sheets. Wrapping paper used in the package protects the sheets from moisture or contamination. Therefore, when the sheets are taken out from the package, all of the sheets are preferably stored in the sheet storage unit to prevent the moisture or contamination.

In order to prevent sheets from remaining without being fit in the sheet storage unit, a method for notifying a user of a sheet amount which can be replenished to the sheet storage unit by a unit of package is known. For example, according to Japanese Patent Application Laid-Open No. 2010-235242, the number of sheet packages to be replenished are displayed on an operation screen from a sheet replenishable height and a thickness of the sheet package.

However, according to Japanese Patent Application Laid-Open No. 2010-235242, when a user intends to change a type of sheets stored in the sheet storage unit, the user cannot easily know how many packages of sheets can be replenished.

For example, the number of replenishable packages which is displayed is calculated based on the type of sheet before the change, which is inserted at present. Therefore, depending on the type of a sheet to be changed hereafter, the number of replenishable packages may be different. More specifically, when a user intends to insert thick paper into a sheet storage unit in which currently thin paper is stored, a bundle height of one package of the thick paper is higher than that of the thin paper. As a result, the number of packages to be able to replenished is decreased, but actually, since the number of packages is displayed based on the thickness of thin paper stored at present, the incorrect number of packages is displayed to the user.

Therefore, the user may open a package which need not be opened under normal circumstances. In this case, when the package is sealed, sheets in the package are protected from humidification, but an effect thereof cannot be expected.

Further, according to Japanese Patent Application Laid-Open No. 2010-235242, the number of packages to be replenished is calculated based on a sheet remaining amount which remains in the sheet storage unit at present.

However, realistically, since all of the sheets which remain in the sheet storage unit are replaced, the number of packages to be replenished, which is calculated based on the remaining thin paper, is not based on thick paper to be replaced, for example. Therefore, an error may cause between thick paper to be replenished after removing the thin paper and the calculated number of packages to be replenished, and a package of thick paper is needlessly opened, and as a result, the quality of the sheet may deteriorate.

### SUMMARY OF THE INVENTION

According to an aspect of the present disclosure, a printing apparatus includes a receiving unit configured to receive a type of a sheet stored in a sheet storage unit, a determining unit configured to specify a number of sheet packages to be replenished in the sheet storage unit according to the type of the sheet received by the receiving unit in a case where the type of the sheet received by the receiving unit is different from a type of a sheet already stored in the sheet storage unit, and a display unit configured to display the number of sheet packages specified by the determining unit.

Further features of the present disclosure will become apparent from the following description of exemplary embodiments with reference to the attached drawings.

### BRIEF DESCRIPTION OF THE DRAWINGS

FIG. 1 is a cross-sectional view illustrating a configuration of a printing apparatus.

FIG. 2 is a block diagram illustrating a hardware configuration of a controller system of the printing apparatus.

FIGS. 3A and 3B illustrate an example of a user interface (UI) screen displayed in an operation unit illustrated in FIG. 2.

FIGS. 4A and 4B illustrate an example of a UI screen displayed in the operation unit illustrated in FIG. 2.

FIGS. 5A and 5B illustrate an example of a UI screen displayed in the operation unit illustrated in FIG. 2.

FIG. 6 is a cross-sectional view illustrating a configuration of a sheet tray illustrated in FIG. 1.

FIG. 7 is a flowchart illustrating a method for controlling the printing apparatus.

FIG. 8 is a flowchart illustrating a method for controlling the printing apparatus.

FIG. 9 is a flowchart illustrating a method for controlling the printing apparatus.

FIG. 10 illustrates an example of a UI screen displayed in the operation unit illustrated in FIG. 2.

FIG. 11 illustrates an example of paper usage status information.

FIG. 12 is a flowchart illustrating a method for controlling the printing apparatus.

FIG. 13 is a flowchart illustrating a method for controlling the printing apparatus.

FIG. 14 illustrates an example of the UI screen displayed in the operation unit illustrated in FIG. 2.

### DESCRIPTION OF THE EMBODIMENTS

<Description of System Configuration>

First, a function of a digital multifunction peripheral as a first exemplary embodiment of a printing apparatus according to the present disclosure will be described. The digital multifunction peripheral is an apparatus including an image reader for reading a paper document and a laser printer for forming an image with use of an electrophotographic method. Further, according to the present exemplary embodiment, the digital multifunction peripheral includes a left deck 23, a right deck 22, a third stage cassette 24, and a fourth stage cassette 25 each of which is used as a paper deck, as a sheet storage unit capable of storing sheets by the unit of package. However, the present disclosure is not limited this configuration, and may further include a plurality of units that can stores a larger amount of sheets.

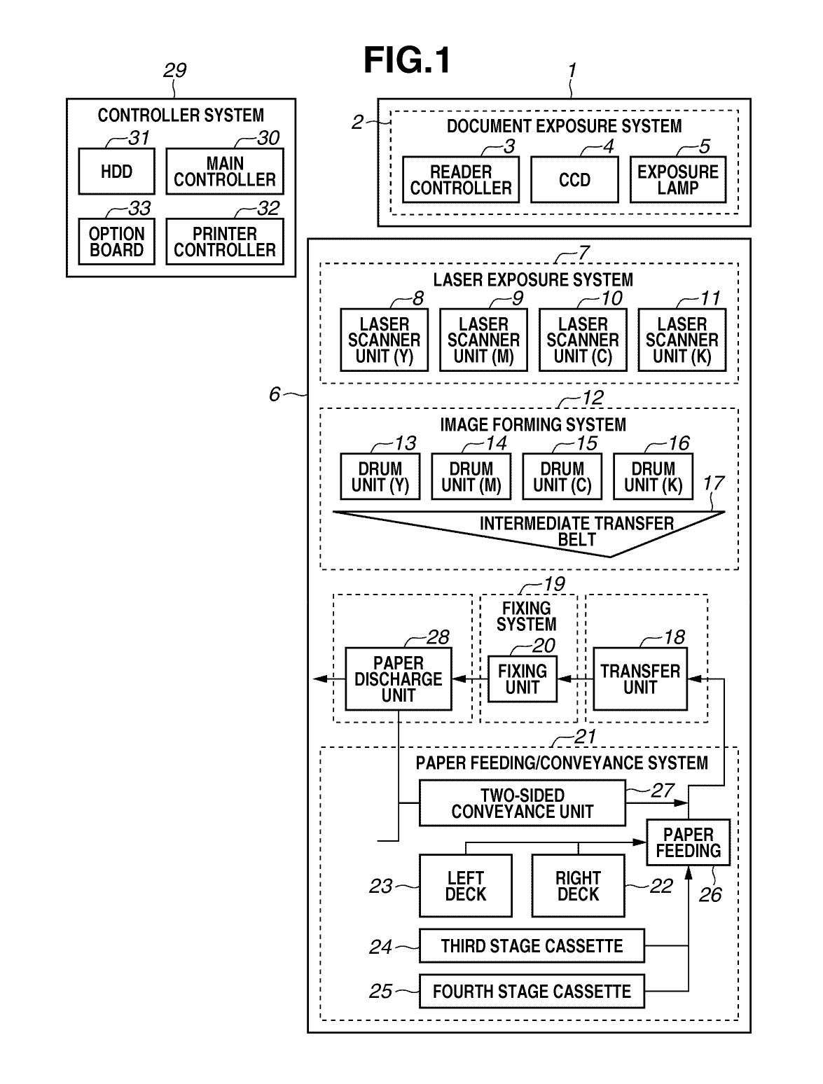

FIG. 1 is a cross-sectional view illustrating a configuration of a printing apparatus. According to the present exemplary embodiment, a digital multifunction peripheral is described as an example of the printing apparatus. A digital multifunction peripheral generally includes six blocks below in terms of a functional configuration installed therein. More specifically, six blocks are a document exposure system 2, a controller system 29, a laser exposure system 7, an image forming system 12, a fixing unit 20, and a paper feeding/conveyance system 21. As used herein, the term “unit” generally refers to any combination of software, firmware, hardware, or other component that is used to effectuate a purpose.

In the controller system 29 illustrated in FIG. 1, a main controller 30 is a control device including a central processing unit (CPU) and a memory and controls the entire digital multifunction peripheral according to a program stored in a hard disc drive (HDD) 31. A printer controller 32 is a controller handling mechanical control of a laser printer unit 6. The printer controller 32 takes responsibility for obtaining a printing output by controlling mechanical parts according to an instruction from the main controller 30.

In an image reader 1, an image of a document is read by a charge coupled device (CCD) 4 by turning on an exposure lamp 5 controlled by a reader controller 3 to be converted into digital data.

In the laser printer unit 6, first, an electrical latent image is formed on a drum unit YMCK of the image forming system 12 by using a laser scanner unit for four colors of yellow (Y), magenta (M), cyan (C), and black (K) which the laser exposure system 7 has.

In drum units 13 to 16 for each of YMCK, a photosensitive drum and a developing unit are configured as one set. The developing unit includes a toner that forms an image and a carrier that supplies electric charges to the toner. The main controller 30 transmits image forming data as a base of an electrical latent image to the laser exposure system 7. The data to be transmitted is data of the document read from the image reader 1 or page description language (PDL) data which the main controller 30 receives from a host computer. The main controller 30 has a network function and is communicable with the host computer. The electrical latent image formed on the photosensitive drum by a laser from the laser scanner unit as described above, is formed as an image when the toner in the developing unit is attached thereto.

Subsequently, the toner is transferred to an intermediate transfer belt 17 which is a belt type photosensitive member. All of images of four colors of YMCK on the drum units 13 to 16 are transferred to the intermediate transfer belt 17, and full-color toner image can be formed thereon. Here, the description of the image forming system 12 is put aside for now, and the paper feeding/conveyance system 21 will be described.

In the paper feeding/conveyance system 21, the right deck 22, the left deck 23, the third stage cassette 24, and the fourth stage cassette 25 are sheet trays for storing printing sheets. The right deck 22 and the left deck 23 can change and printing sheets stored therein can be replenished by a sheet package unit.

The right deck 22 and the left deck 23 may store comparatively small-sized sheets, while the third stage cassette 24 and the fourth stage cassette 25 may store large-sized sheets.

A paper feeding 26 is a mechanism for conveying, to the image forming system 12, the printing sheet drawn from each of the right deck 22, the left deck 23, the third stage cassette 24, and the fourth stage cassette 25.

A two-sided conveyance unit 27 can convey a sheet of which one side is subjected to printing to the image forming system 12 again for two-sided printing. When the printing sheet taken out by the paper feeding/conveyance system 21 is conveyed to a transfer unit 18 in the image forming system 12, the toner image formed on the intermediate transfer belt 17 is transferred onto the printing sheet. Then, the toner image heated and pressed by a fixing roller of the fixing unit 20 is fixed to the printing sheet, and thus, a printed product is generated. The printed sheet is conveyed to the outside of the printer via a paper discharge unit 28. Next, a hardware configuration of the controller system 29 will be described.

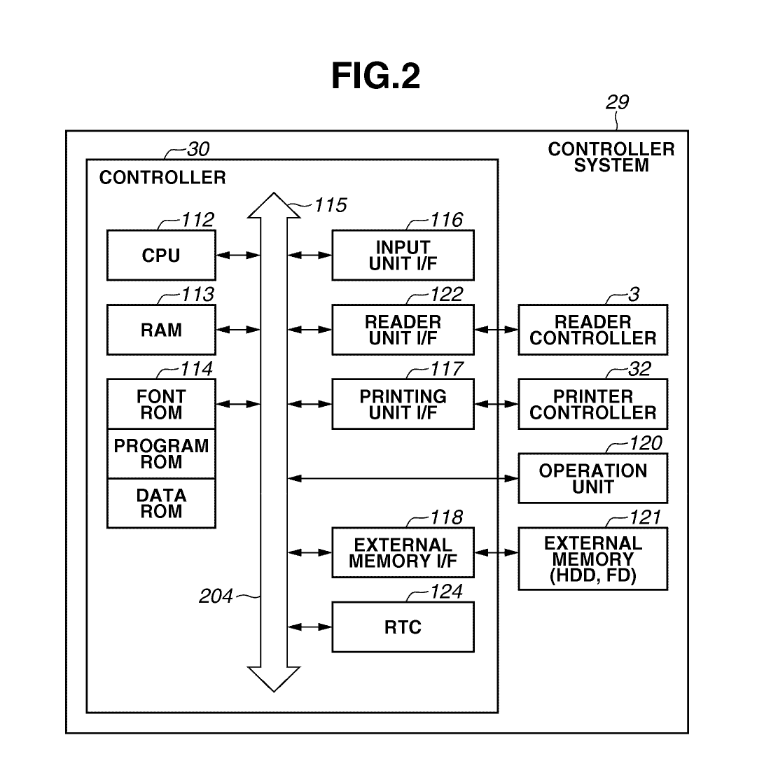

FIG. 2 is a block diagram illustrating a hardware configuration of the controller system 29 of the printing apparatus illustrated in FIG. 1.

In the controller system 29 illustrated in FIG. 2, the main controller 30 is a center of a printer control system and provides a printer function by using a printer controller 32, an operation unit 120, an external memory 121, and the like. A CPU 112 of the main controller outputs an image signal as output information to a printing unit (printer engine) interface (I/F) 117 connected to a system bus 115 based on a control program, and the like. The control program is stored in a program read-only memory (ROM) in a ROM 114 or the external memory 121.

Font data and the like which are used in generating the output information, are stored in a font ROM in the ROM 114. Similarly, in the case of a printer without the external memory 121 such as a hard disk or the like, information and the like which are used on a host computer are stored in a data ROM in the ROM 114.

The printer controller 32 forms a printing image by an electrophotographic process based on an image signal transmitted from the printing unit I/F. The reader controller 3 reads a paper document as electronic data. The CPU 112 can read the electronic data of the reader controller 3 via a reader unit I/F 122.

The CPU 112 can perform communication processing with the host computer via an input unit 116 and is configured to notify the host computer (not illustrated) of information in the printer and the like. A random access memory (RAM) 113 serves as a main memory, a work area, or the like of the CPU 112 and is configured to extend a memory capacity by an option RAM to be connected to an expansion port (not illustrated). The RAM 113 is used as an output information rasterization region, an environment data storage region, a non-volatile random access memory (NVRAM), and the like. An access to the above-described external memory 121 such as a hard disk (HD), an integrated circuit (IC) card, or the like is controlled by an external memory I/F 118.

The external memory 121 is connected as an option and stores font data, an emulation program, form data, and the like.

In an operation unit 120, switches and light-emitting diode (LED) indicators for an operation are arranged therein. The number of the above-described external memories is not limited to one. The controller system 29 may include at least one or more memories, and may be configured to connect a plurality of external memories which stores an option font card and a program to interpret a printer control language with a different language system, in addition to a built-in font. In addition, the controller system 29 may include the NVRAM (not illustrated) and store printer mode setting information from the operation unit 120.

A real-time clock circuit (RTC) 124 is hardware for measuring a time or counting time at regular intervals. Since the RTC 124 operates by receiving power supply from a built-in battery, the RTC itself can continuously operate even though the main controller 30 stops. According to a value written in a register in the RTC from the CPU 112, an interrupt signal is generated at a predetermined time or a constant time and an interrupt may be notified to the CPU 112 which is connected.

Herein, a sheet remaining amount or a sheet addable amount to be displayed on an operation screen on the operation unit 120 will be described with reference to the drawings.

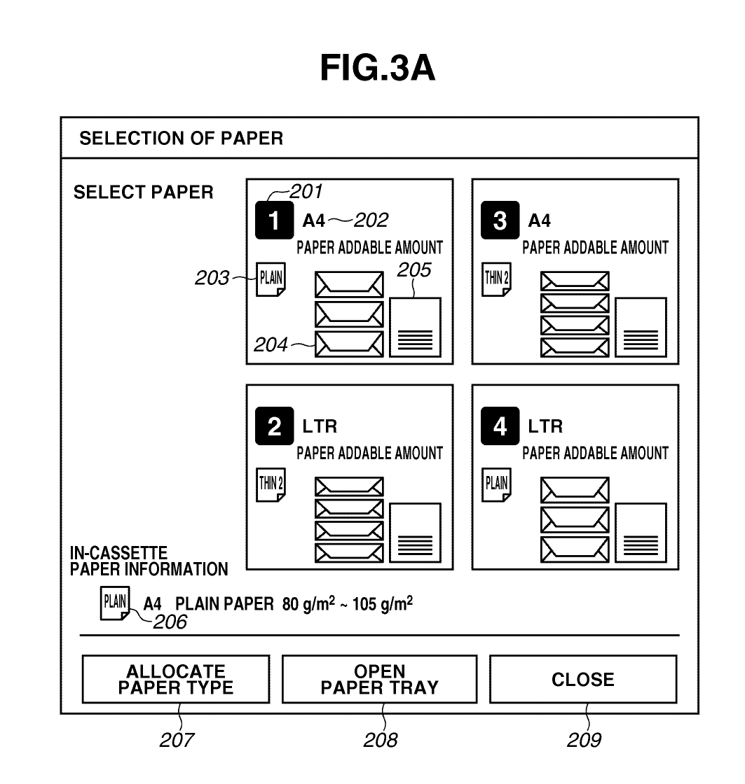

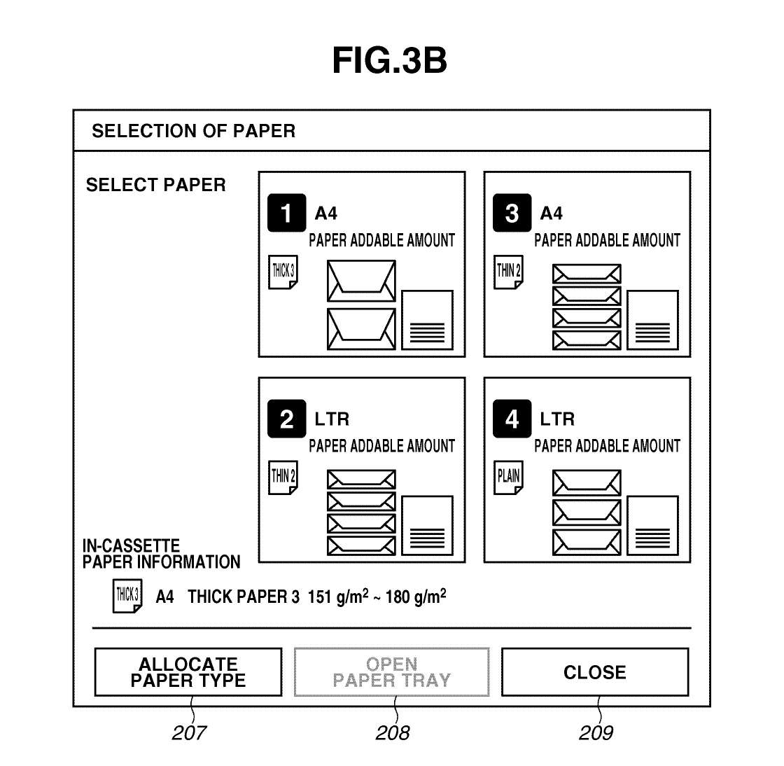

FIGS. 3A, 3B, 4A, 4B, 5A, and 5B illustrate examples of a user interface screen to be displayed in the operation unit 120 illustrated in FIG. 2. FIGS. 3A and 3B illustrate a sheet selection screen displayed in the operation unit 120 of the digital multifunction peripheral. In this example, a sheet selection screen of a digital multifunction peripheral including four sheet trays is illustrated. Information pieces about sheets mounted on the respective sheet trays are displayed for a user to easily understand. Detailed information includes a tray number 201, a sheet size 202, a sheet type icon 203, a sheet remaining amount in the sheet tray 205, and a sheet addable amount (the number of packages) 204.

The sheet tray includes a sheet remaining amount detecting mechanism to be described below, and the CPU 112 calculates a sheet addable amount from a sheet stackable amount in the sheet tray and a height of added sheet packages and displays the sheet addable amount as the number of packages. A method for calculating the sheet addable amount will be described below.

When a user knows the number of addable packages, it is possible for the user to replenish printing sheets without opening an extra package and generating remaining sheets which cannot be replenished. A sheet information display column 206 in the sheet tray is provided on the sheet selection screen. The sheet information display column 206 is configured to display information which cannot be displayed by only an icon of the sheet tray selected at present. In FIG. 3A, a paper grammage is displayed by a numerical value as the sheet type, thus more detailed sheet attribute can be provided. In addition, three buttons are provided in a lowermost part of the sheet selection screen. A sheet type allocation button 207 is configured to change the sheet type in the sheet tray.

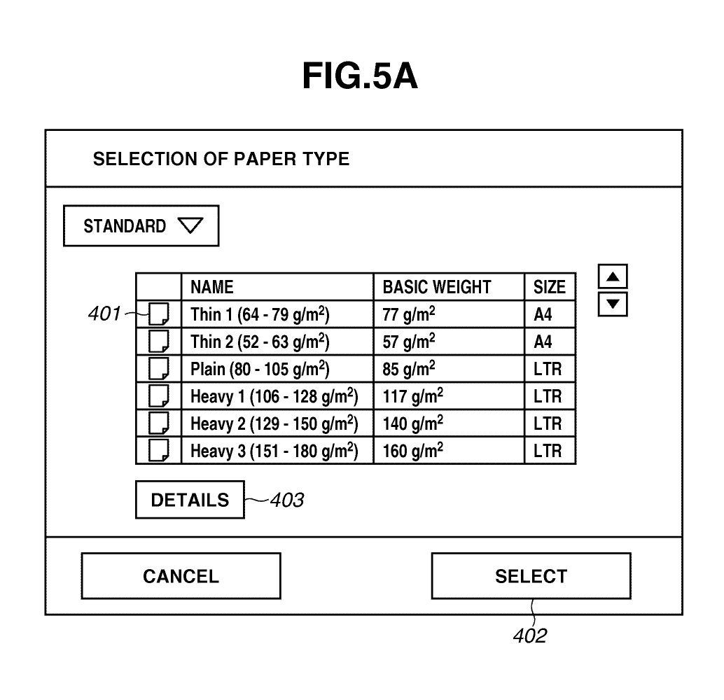

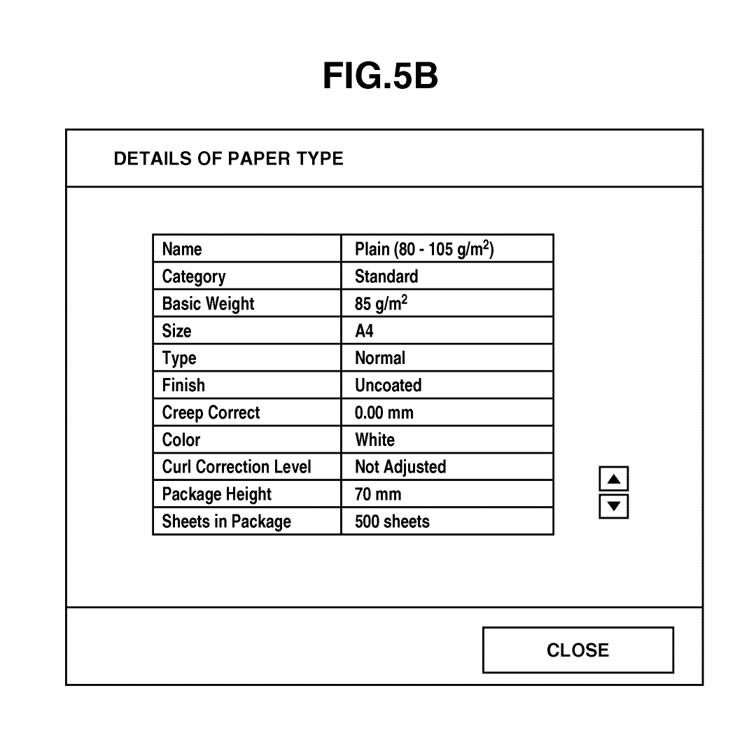

When the user presses the sheet type allocation button 207, the user can select the sheet allocated to a desired sheet tray by the sheet type selection screen illustrated in FIG. 5A for inputting a type of a replaced sheet. A sheet tray open button 208 is a button for opening the sheet tray. If the user selects a tray number to open in advance, the user can open the desired sheet tray by pressing the button 208. Last, a close button 209 is configured to close the sheet selection screen and display another operation screen by closing the dialogue.

Herein, a method for calculating the sheet addable amount will be described together with a mechanism of the sheet tray.

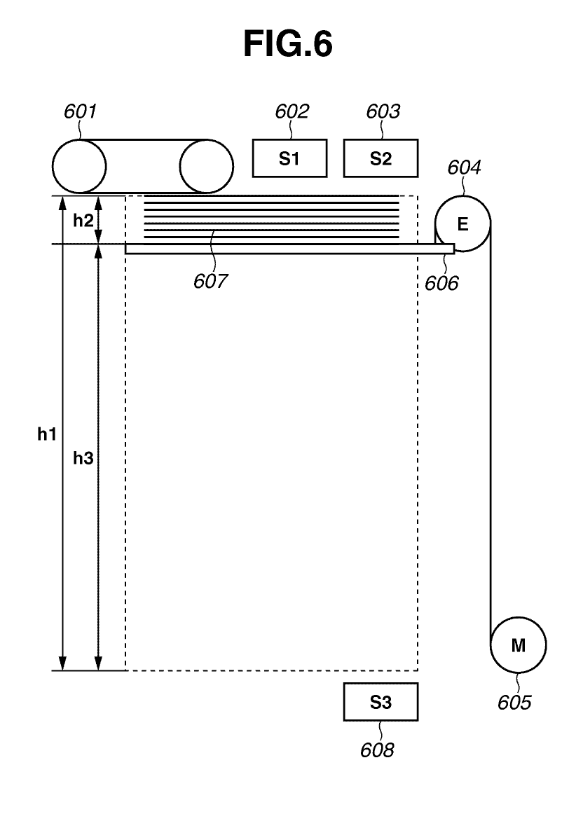

FIG. 6 is a cross-sectional view illustrating a configuration of the sheet tray illustrated in FIG. 1. This example illustrates a case in which the left deck 23 and the right deck 22 illustrated in FIG. 1 are used as the sheet trays.

In FIG. 6, a lifter motor 605 is a motor for lifting a deck lifter 606 and printing sheets 607 loaded thereon.

The lifter motor 605 and the deck lifter 606 are connected to each other by a wire via a pulley. An encoder 604 is connected to the pulley. When a rotational degree of the pulley is measured by the encoder 604, a lifting degree of the deck lifter 606 can be obtained.

A sheet surface detection sensor 602 is configured to detect a top surface of the printing sheet 607 and a sheet presence sensor 603 is a sensor for determining whether the printing sheet is present on the deck lifter 606.

A lifter lower-limit sensor 608 detects that the deck lifter 606 is at a lower limit. The deck lifter 606 moves down to the lower limit when the sheet tray is opened. A sheet feeding roller 601 is configured to take out the lifted printing sheet one by one.

When the lifter lower-limit sensor 608 makes a response, the number of accumulated pulses of the encoder is first reset to “zero”. When the sheet tray is closed, the deck lifter 606 of the sheet tray starts to move up by the lifter motor 605. When the sheet surface detection sensor 602 makes a response, it is determined that the printing sheet 607 reaches a sheet feedable position, and thus, the lifter motor 605 stops.

Herein, the CPU 112 calculates a sheet height h2 using the number of accumulated encoder pulses. Further, the CPU 112 can calculate a sheet addable amount h3 from an in-tray accommodation height h1 which is stored as a design value. In addition, the CPU 112 divides the sheet addable amount h3 by a height of one package for each sheet type to calculate the sheet addable amount as the package number. Herein, a relationship of h1=h+h3 is established.

The height of one package of each sheet type is stored in a sheet catalogue in advance. Sheet catalogue data is a database of the sheet type stored in the external memory 121 of the printing apparatus.

An attribute for each sheet type is stored in each entry of the database. Herein, the attribute refers to a value such as a name, a basic grammage, a size, a surface property, or the like, in detail. These attributes are indicated in the sheet type selection screen illustrated in FIG. 5A displayed on the operation unit 120, so that the user can check the values. A package height is one of these attributes. The number of sheets included in one package is also recorded as the attribute together with the package height.

FIG. 5B illustrates an example of a detailed sheet type screen for checking the attributes. In this example, the package height is 70 mm and 500 sheets are included in one package. Of course, since all sheet types are unable to be prepared in advance, the attributes are editable by the user.

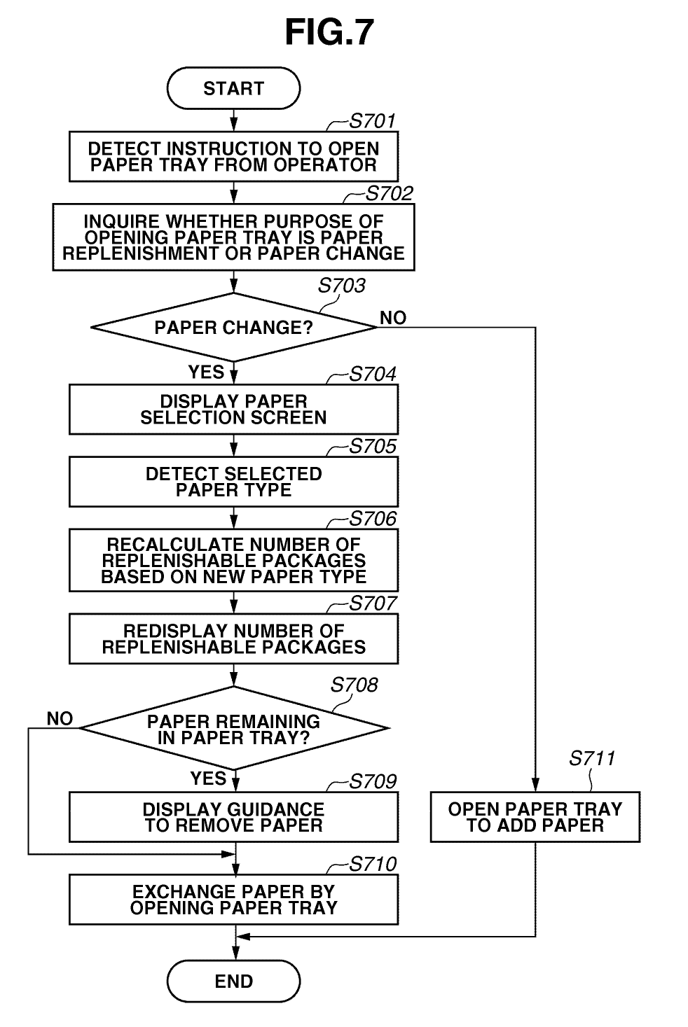

Hereinbelow, a behavior of the digital multifunction peripheral when an instruction to open the sheet tray is issued according to the present exemplary embodiment will be described with reference to a flowchart illustrated in FIG. 7. Herein, the sheet tray collectively means the left deck 23, the right deck 22, the third stage cassette 24, and the fourth stage cassette 25 which are illustrated in FIG. 1, and in the following description, these decks and cassettes will be simply described as a sheet tray if not particularly specified.

FIG. 7 is a flowchart illustrating a method for controlling the printing apparatus according to the present exemplary embodiment. A program according to the flowchart is stored in the external memory 121, read by the RAM 113, and executed by the CPU 112.

First, processing until display of the number of replenishable sheet packages is updated will be described.

First, in step S701, the CPU 112 of the main controller illustrated in FIG. 2 detects an instruction from a user to open the tray.

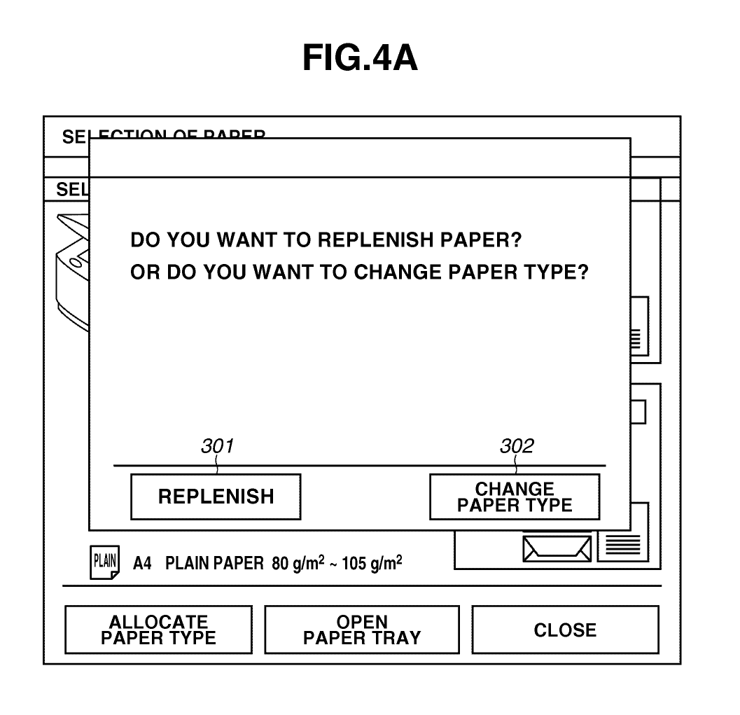

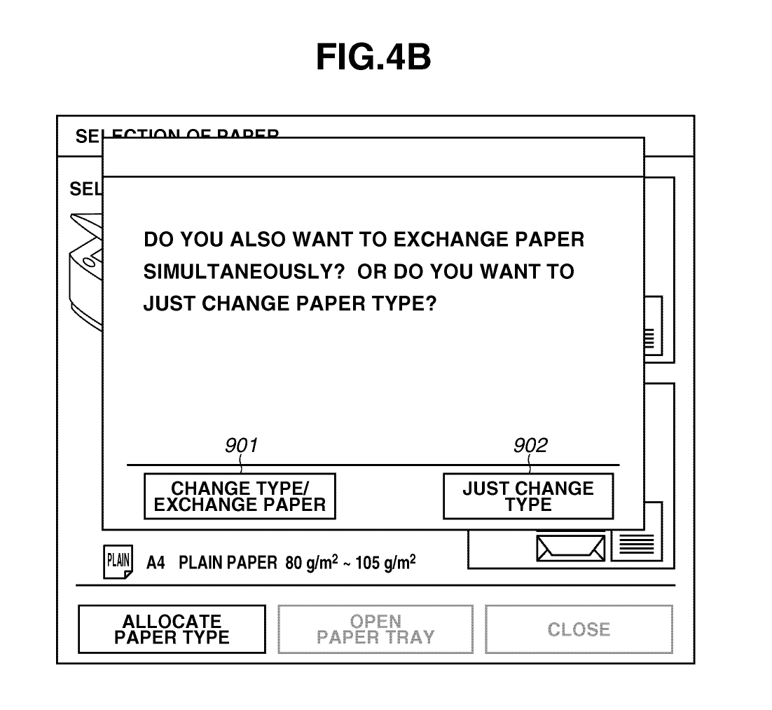

In step S702, the CPU 112 displays a purpose confirmation screen (see FIG. 4A) for opening the sheet tray to the operation unit 120 in order to confirm whether a purpose to open the sheet tray is just replenishing the sheet or changing the type of the sheet for using another sheet.

FIG. 4A illustrates a detailed example of the purpose confirmation screen for receiving an instruction to replenish sheets of the same type or an instruction to replace present sheets with sheets of another type to the left deck 23 or the right deck 22. As such, according to the present exemplary embodiment, an instruction to replenish sheets of the same type or an instruction to replace the present sheets with sheets of another type to a sheet deck is received by the UI screen as illustrated in FIG. 4A.

The CPU 112 displays a replenishing button 301 and a sheet type change button 302 together with a guidance on the purpose confirmation screen illustrated in FIG. 4A and allows the user to make a selection. Then in step S703, the CPU 112 waits for an instruction to change selection of a button which the user performs by operating the operation unit 120 and determines whether the sheet type change button 302 is pressed which is an instruction to change the sheet.

In step 5703, if the CPU 112 determines that the replenishing button 301 is pressed by the user, that is, if the CPU 112 determines that the purpose is just replenishing the sheet, an additional replenishment amount displayed at present is correct. In this case (NO in step S703), since recalculation of the number of packages is not required, and in step S711, the sheet tray is just opened and sheets currently used are additionally replenished. Then, the CPU 112 terminates the processing.

Meanwhile, in step S703, if the CPU 112 determines that the user presses the sheet type change button 302 indicating the change of the sheet type (YES in step S703), then in step S704, the CPU 112 displays the sheet selection screen (see FIG. 5A) on the operation unit 120. FIG. 5A illustrates a detailed example of the sheet selection screen.

In FIG. 5A, a sheet type list 401 is displayed at the center of the screen. Herein, the user can select a type of a sheet to be used from the list and presses a selection button 402 to determine the sheet type.

In step S705, the CPU 112 detects the selected sheet type by reading an item selected by the user on the sheet type selection screen illustrated in FIG. 5A.

Then in step S706, the CPU 112 recalculates the number of replenishable packages. At this point, sheets before exchange remain in the sheet tray. However, when the sheet type is changed, the sheets are different from sheets after the change in thickness of the sheet, thus, the sheet in the sheet tray cannot be used to recalculate the number of packages.

In addition, since the user removes the remaining sheet after opening the sheet tray, if the number of packages is calculated by using the sheet remaining amount, the number of packages becomes an incorrect value. Therefore, the CPU 112 recalculates the number of packages by assuming that no sheet is present in the sheet tray. More specifically, when the received instruction is to replace the present sheet with the sheet of another type, the CPU 112 calculates the number of sheet packages which can be replenished in a selected sheet storage unit by referring to sheet type information stored in association with an input sheet type.

In step S707, the CPU 112 redisplays the number of replenishable packages which is displayed on the operation unit 120 (see FIG. 3B as a screen example of displaying the calculated number of sheet packages). FIG. 3B illustrates an example of the sheet selection screen on which the number of packages is redisplayed.

In this example, a sheet type of a sheet tray 1 of which tray number 201 is “1” is replaced from “plain paper” to “thick paper 3”, and as a result, the number of addable packages becomes “2”. According to the present exemplary embodiment, it is assumed that the sheet tray 1 of which tray number 201 is “1” corresponds to the left deck 23.

Then in step S708, the CPU 112 determines whether the sheet remains in the sheet tray 1 based on an output of the sheet presence sensor 603.

If the CPU 112 determines that the sheet remains (YES in step S708), then in step S709, the CPU 112 displays a guidance for the user on the operation unit 120 so as not to forget to remove the sheet. According to the present exemplary embodiment, when the sheets of another type are replenished in a deck selected by the user, the guidance for taking out the sheets before replenishment from the deck is notified to the user and can call user's attention about forgetting to remove the remaining sheets. Lastly, in step S710, the CPU 112 opens the sheet tray, and the user replaces the sheets. Thus, the processing is terminated.

According to the above-described present exemplary embodiment, a case in which the sheet remaining amount is detected by a movement distance of the deck lifter 606 by the encoder 604 is described. However, since a certain amount of error may not be avoided in mechanical measurement, an error of approximately dozens of sheets occurs. Meanwhile, on the assumption that the sheets are replenished by the unit of package, the sheet remaining amount may be more accurately managed. Further, it is possible to more accurately estimate a time when the sheets need to be replenished.

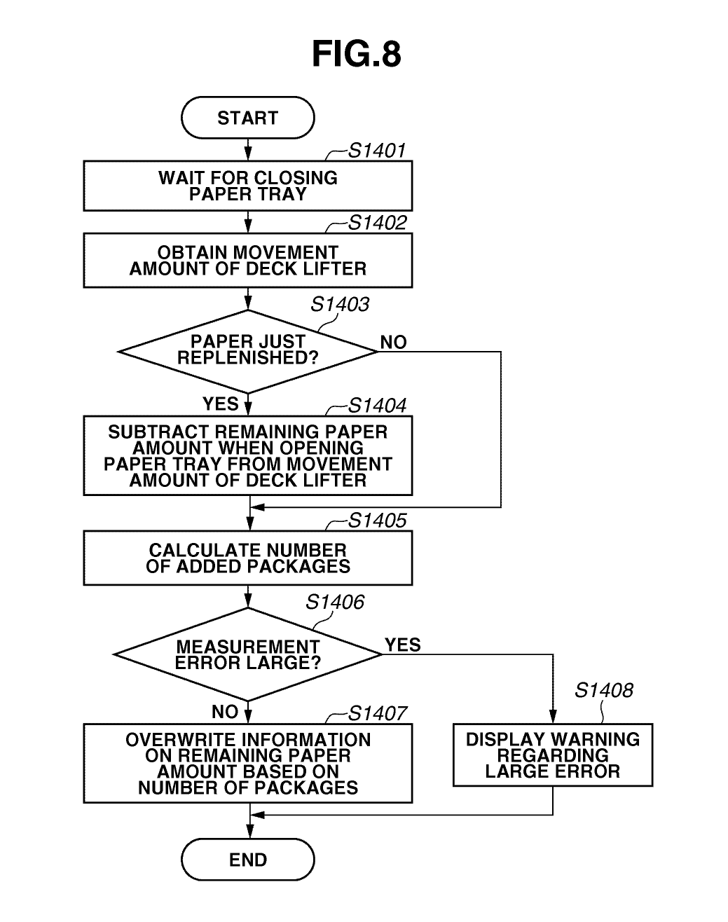

Hereinbelow, a method for managing the sheet remaining amount on the assumption that the sheets are replenished by the unit of package will be described with reference to a flowchart illustrated in FIG. 8.

FIG. 8 is the flowchart illustrating a method for controlling the printing apparatus according to the present exemplary embodiment. A program of the digital multifunction peripheral according to the flowchart is stored in the external memory 121, read by the RAM 113, and executed by the CPU 112.

First, description of the method is started from a state in which a user opens the sheet tray for “sheet replenishment” or “sheet exchange”. In step S1401, the CPU 112 waits until the sheet tray is closed by monitoring an output of a sensor.

When the sheet tray is closed, the deck lifter 606 starts to move up and stops moving up when responding to the sheet surface detection sensor 602. In step S1402, the CPU 112 reads a value of the encoder 604 to read a movement amount of the deck lifter 606.

At that time, if the sheet tray is empty, a sheet replenishment amount may be simply calculated from the movement amount, however if a remaining sheet is present, calculation considering the remaining sheet needs to be performed. Therefore, in step S1403, the CPU 112 determines whether the sheet replenishment is “just sheet replenishment” or is accompanied by “change of the sheet type”.

The determination is performed using the processing described in step S703 in the flowchart in FIG. 7. If the CPU 112 determines that the sheet replenishment is “just sheet replenishment” (YES in step S1403), then in step S1404, the CPU 112 subtracts the value considering the sheet remaining amount which is stored before opening the sheet tray from the movement amount of the deck lifter.

A value obtained by dividing the resulting movement amount of the deck lifter by the height of the sheet package stored in the sheet catalogue becomes the number of additional packages (S1405).

Herein, the CPU 112 performs checking considering when the sheets are not replenished by the unit of package. More specifically, the CPU 112 also obtains a remainder obtained by dividing the movement amount of the deck lifter by the package height in step 51405.

In step S1406, the CPU 112 determines whether the sheets are replenished by the unit of package based on the size of a measurement error, in other words, whether a value obtained by converting the reminder into the number of sheets is larger than a predetermined value. That is, whether the user replenishes the sheet by the sheet package unit is determined based on a degree of the error.

If the CPU 112 determines that the measurement error is small (NO in step S1406), then in step S1407, the CPU 112 determines that the sheet replenishment is performed by the unit of package, and adopts, as a new sheet remaining amount, a value obtained by adding the sheet remaining amount to a value obtained by multiplying the number of packages by the number of sheets per package. Then, the CPU 112 terminates the processing. Accordingly, when it is determined that the sheets are replenished by the sheet package unit in step S1406, a remaining amount of the replenished sheets is updated to a value of the number of sheets specified by the sheet package unit.

Meanwhile, if the CPU 112 determines that the generated measurement error is larger (YES in S1406), in step S1408, the CPU 112 manages the sheet remaining amount based on the movement amount of the deck lifter 606 without managing the number of sheets by the unit of package. In this case, the CPU 112 displays a warning on the operation unit 120 indicating to the user that the processing is not performed by the unit of package because the error is large.

Accordingly, when the sheets are replaced by changing the type of the sheet, the accurate number of sheet packages to be opened can be notified to the user. Further, since the sheet package is not needlessly opened, the sheet package can be conserved and managed without being influenced by moisture and the like.

According to the first exemplary embodiment, a case in which a user issues an instruction to open a sheet tray is described. However, a case in which an instruction to change the sheet type without opening the sheet tray also needs to be considered. This is because the user may change allocation of the sheet type to each sheet tray before replacing the sheets when a printing job is changed.

In the sheet selection screen in FIG. 3A, the user presses the sheet type allocation button 207 to change the sheet type of the sheet tray. Even in this case, the number of addable sheet packages is displayed according to the sheet type so that the user would not make a mistake.

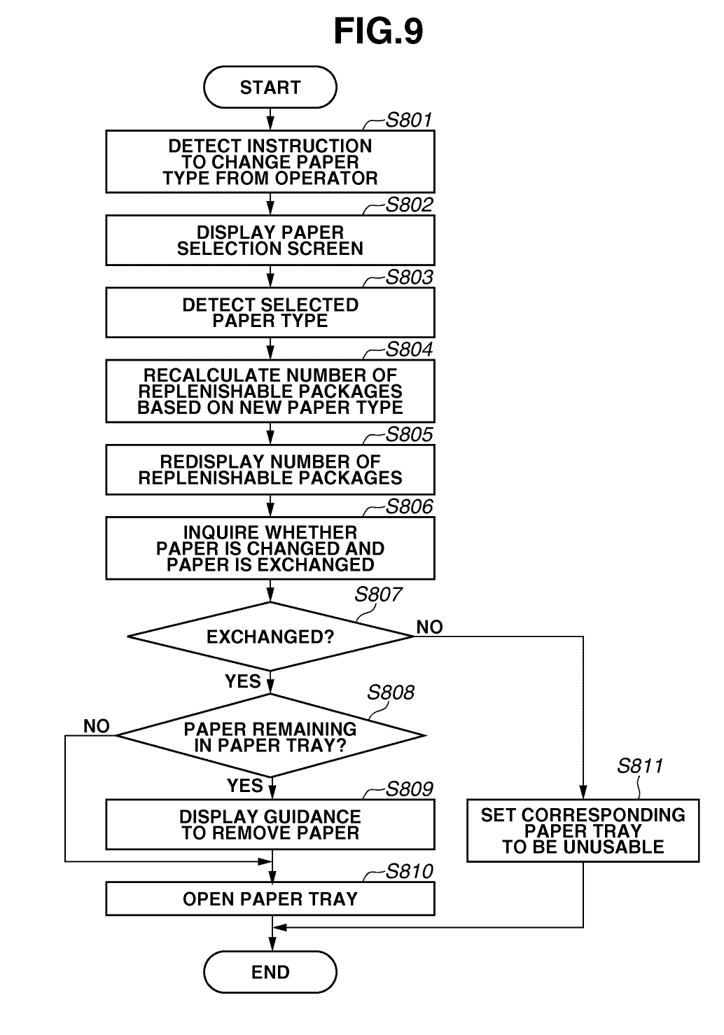

Next, a behavior of a digital multifunction peripheral at the time of changing the sheet type according to a second exemplary embodiment will be described with reference to a flowchart illustrated in FIG. 9.

FIG. 9 is the flowchart illustrating a method for controlling a printing apparatus according to the second exemplary embodiment. A program of the digital multifunction peripheral according to the flowchart is stored in the external memory 121, read by the RAM 113, and executed by the CPU 112.

First, processing until display of the number of replenishable sheet packages is updated will be described.

In step S801, the CPU 112 of the main controller detects an instruction to change the sheet allocation by a user.

A series of processing flows (S802 to S805) from display of the sheet selection screen to redisplay of the number of replenishable packages are the same as the processing (S704 to S707) in FIG. 7, and thus descriptions thereof will be omitted.

At the time when the redisplay ends, in step S806, the CPU 112 displays a screen for confirming whether to simultaneously perform a sheet exchange operation on the operation unit 120.

FIG. 4B illustrates an example of the confirmation screen. The CPU 112 detects which of a type change/sheet exchange button 901 and a type change button 902 on the operation screen is pressed to know the user's selection.

Next, in step S807, the CPU 112 waits for a user's selection after displaying the confirmation screen on the operation screen and determines whether an instruction from the user is an exchange instruction by the type change/sheet exchange button 901.

If the CPU 112 detects the selection of the exchange (YES in step S807), the processing proceeds to step S808. In step S808, before opening the sheet tray to exchange the sheets, the CPU 112 determines whether there is a sheet which remains unused in the sheet tray based on an output of the sheet presence sensor 603.

If the CPU 112 determines that the sheet remains (YES in step S808), in step S809, a guidance to remove the sheet is displayed on the operation unit 120. In step S810, the sheet tray is opened, thus the user exchanges the sheets and closes the sheet tray. Then, the CPU 112 terminates the processing.

In the determination processing in step S807, if it is detected that the user does not exchange the sheet (NO in step S807), in step S811, the CPU 112 puts the sheet tray of which sheet allocation is changed into an unusable state, and terminates the processing.

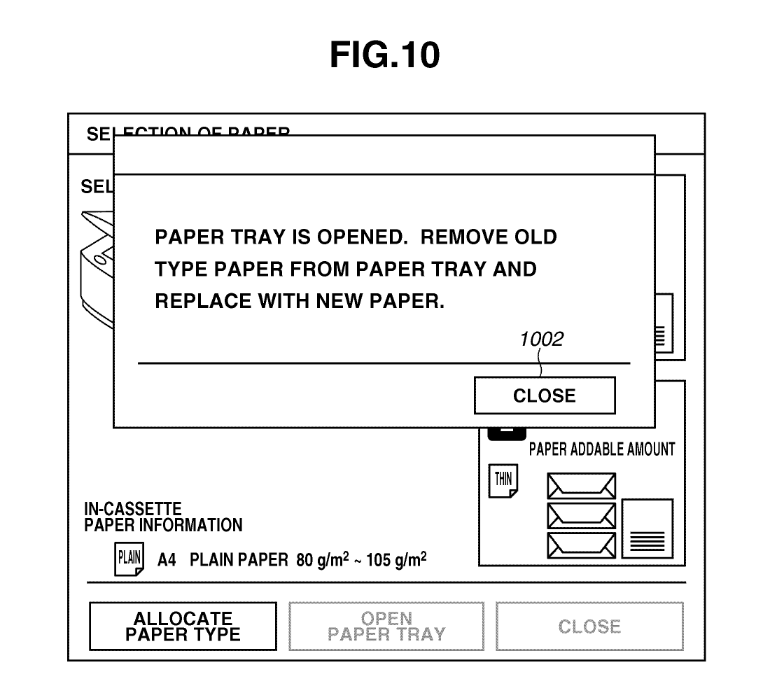

By this processing, it is possible to prevent a job input later from incorrectly using the sheet in which only the allocation is changed. FIG. 10 illustrates an example of an unusable status of the relevant sheet tray after changing the sheet allocation. In the example, the sheet tray 1 (corresponding to the left deck 23 of the tray number 201) is in the unusable state, and as a result, display is also grayed out on the screen.

According to the first exemplary embodiment and the second exemplary embodiment, an operation to remove a sheet which remains unused in the sheet tray occurs at the time of exchanging the sheet. If the removed sheet is left as it is, the type of the sheet may not be distinguished. Such a situation may cause an issue when the sheet is inserted into the sheet tray again. As a countermeasure, a usage status at the time of taking out the sheet is printed as a paper usage status sheet, and at the same time a usage status before exchanging the sheets is stored in the digital multifunction peripheral. Accordingly, the sheet before the exchange can be easily used again. Hereinbelow, a third exemplary embodiment will be described.

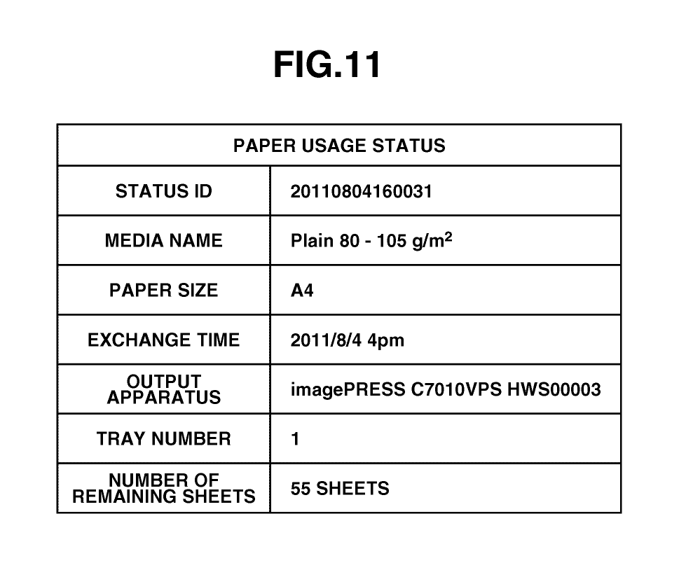

FIG. 11 illustrates an example of a paper usage status managed by a printing apparatus according to the third exemplary embodiment. When the exchanged sheets are kept, the paper usage status sheet is placed on the top of the sheets, and as a result, the user can recognize a feature of the sheet. In addition, the user can easily compare the paper usage status with the usage status before the exchange which is stored in the digital multifunction peripheral. According to the present exemplary embodiment, an example in which a sheet remaining amount removed at the time of exchanging/replenishing the sheets is managed in association with sheet information for identifying the sheet is described.

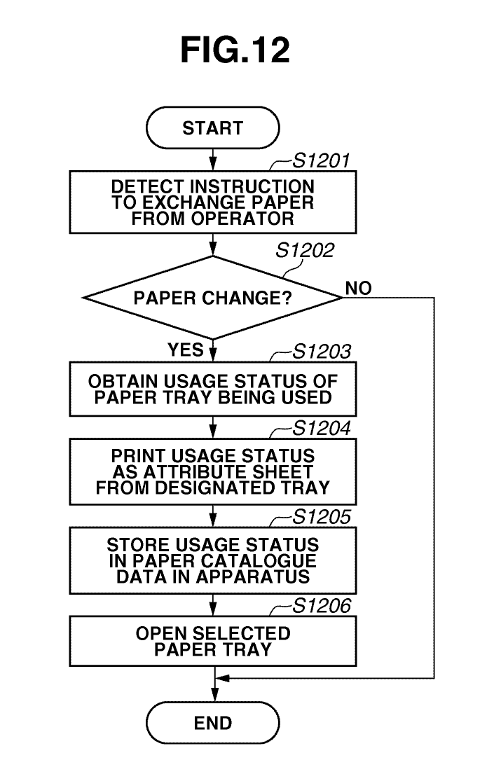

Hereinbelow, a processing flow of printing a paper usage status sheet at the time of exchanging the sheets and storing the usage status will be described with reference to FIG. 11 and a flowchart in FIG. 12.

FIG. 12 is the flowchart illustrating a method for controlling the printing apparatus according to the present exemplary embodiment. A program of the digital multifunction peripheral according to the flowchart is stored in the external memory 121, read by the RAM 113, and executed by the CPU 112.

First, the processing in FIG. 12 at the time of exchanging the sheet will be described. In step S1201, the CPU 112 displays the sheet selection screen in FIG. 3A and waits for an instruction from the user by pressing the button.

Subsequently, in step S1202, the CPU 112 determines whether the user's instruction is the change of the sheet type allocation (the sheet exchange). If the CPU 112 determines that the sheet type is not changed (NO in step S1202), the processing is terminated without performing any processing.

Meanwhile, if the CPU 112 detects that the change of the sheet type is selected by the user (YES in step S1202), in step S1203, the usage status in the sheet tray which is subjected to the change is read from the

RAM 113 in the main controller.

In step S1204, the CPU 112 converts the obtains usage status in the sheet tray subjected to the change into a printing image and then, performs printing the printing image as the paper usage status sheet by using a sheet tray designated by the user. When the printing is completed, in step S1205, the CPU 112 stores the usage status obtained in step S1203 in a corresponding entry of the sheet catalogue data in the apparatus.

Next, after the CPU 112 stores the usage status, in step S1206, the sheet tray selected by the user is opened, and the processing is terminated.

Accordingly, the user can take out a sheet which remains in the sheet tray and may keep the remaining sheet by placing the printed paper usage status sheets thereon.

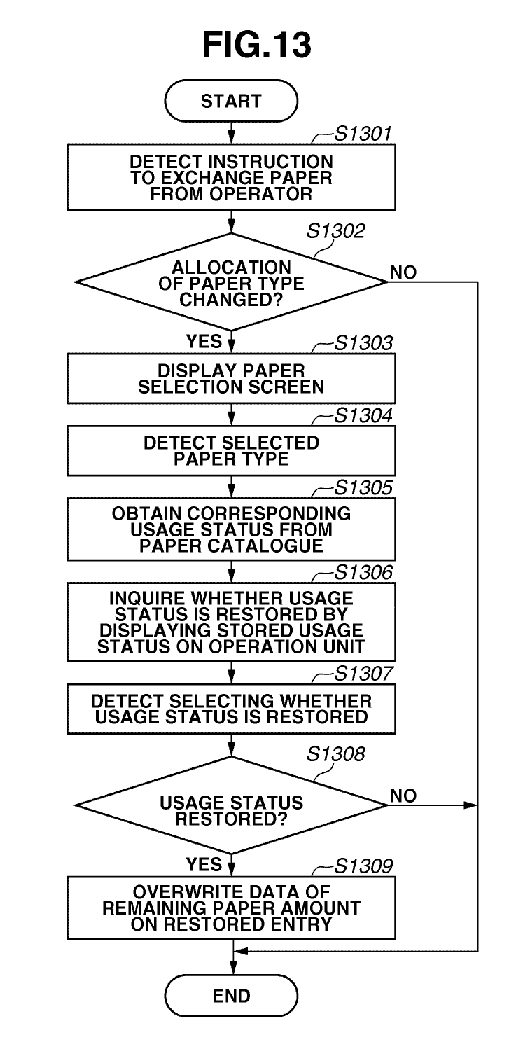

FIG. 13 is a flowchart illustrating a method for controlling the printing apparatus according to the present exemplary embodiment. The example is a processing example at the time of returning the remaining sheet to the sheet tray again. A program of the digital multifunction peripheral according to the flowchart is stored in the external memory 121, read by the RAM 113, and executed by the CPU 112.

First, in step S1301, the CPU 112 detects a sheet exchange instruction from the user. The user presses the sheet allocation button on the sheet selection screen illustrated in FIG. 3A to issue the exchange instruction. In step S1302, the CPU 112 determines whether the user's selection is the sheet type allocation. If the CPU 112 determines that the selection is the sheet type allocation (YES in step S1302), then in step S1303, the CPU 112 displays the selection screen of the sheet type in FIG. 5A.

Subsequently in step S1304, the CPU 112 detects the sheet type selected by the user by a touch panel on the operation unit 120.

In step S1305, the CPU 112 takes out information corresponding to the selected sheet type from the sheet catalogue data. In addition, a usage status corresponding to the selected sheet type which is recorded is extracted from the corresponding information. The recorded usage status may not be one. In a case where the same media is used in a plurality of sheet trays, a plurality of usage statuses may be recorded.

Next in step S1306, the CPU 112 displays the recorded usage status on the operation unit 120 and inquires the user whether to use the value at the time of restoration.

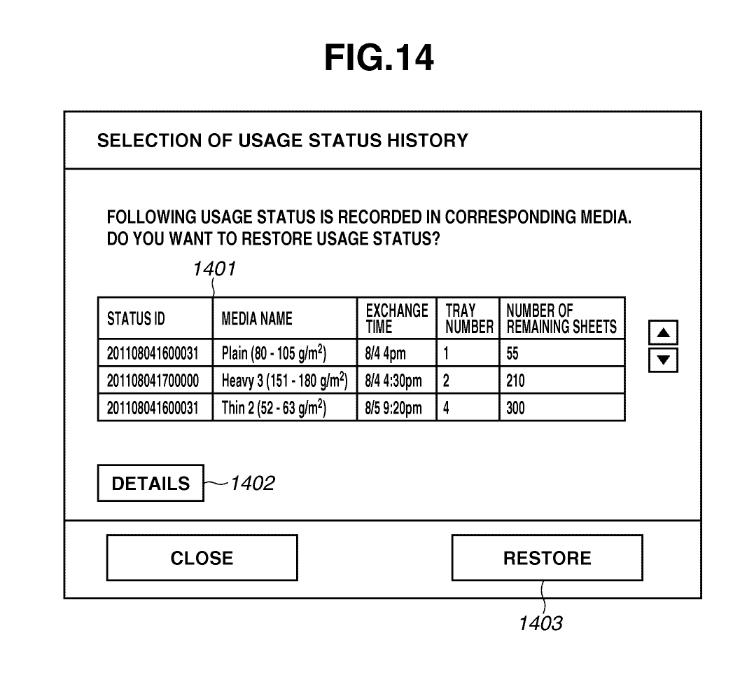

FIG. 14 illustrates an example of a user interface screen displayed on the operation unit 120 illustrated in FIG. 2. The example is an example of a paper usage status history selection screen displayed on the operation unit 120.

The user compares a status identification (ID) 1401 with an ID printed on the above-described paper usage status sheet to determine which history is to be used. In step S1307, the CPU 112 detects a selection of the usage status history selected by the user, and when the CPU 112 determines that the restoration is selected (YES in step S1308) by restoration key 1403, information regarding the number of remaining sheets is extracted from the history information.

After a door for the sheet tray is closed and the deck lifter 606 moves up, in step S1309, if there is no large difference between detection of the remaining amount by the encoder 604 and a value of the history information, the value of the history information is adopted as the sheet remaining amount in the sheet tray, and the processing is terminated.

Accordingly, the CPU 112 can more accurately manage the number of sheets with use of a value of the remaining amount of sheets which is restored in subsequent sheet remaining amount management.

Embodiments of the present disclosure can also be realized by a computer of a system or apparatus that reads out and executes computer executable instructions recorded on a storage medium (e.g., a non-transitory computer-readable storage medium) to perform the functions of one or more of the above-described embodiment(s) of the present disclosure, and by a method performed by the computer of the system or apparatus by, for example, reading out and executing the computer executable instructions from the storage medium to perform the functions of one or more of the above-described embodiment(s). The computer may comprise one or more of a CPU, micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2012-124903 filed May 31, 2012, which is hereby incorporated by reference herein in its entirety.

What is claimed is:

1. A printing apparatus comprising:
a receiving unit configured to receive a type of a sheet stored in a sheet storage unit;
a determining unit configured to specify a number of sheet packages to be replenished in the sheet storage unit according to the type of the sheet received by the receiving unit in a case where the type of the sheet received by the receiving unit is different from a type of a sheet already stored in the sheet storage unit; and
a display unit configured to display the number of sheet packages specified by the determining unit.

2. The printing apparatus according to claim 1, wherein,
in a case where a different type of sheet is replenished to the sheet storage unit, the display unit displays a message for prompting a user to take out the sheet already stored in the sheet storage unit.

3. The printing apparatus according to claim 1, further comprising:
a detecting unit configured to detect a status of taking out the sheet already stored in the sheet storage unit.

4. The printing apparatus according to claim 1, further comprising:
a judging unit configured to determine whether replenishment of sheets in the sheet storage unit is executed by a sheet package unit; and
a changing unit configured to change a remaining amount of replenished sheets to the number of sheets determined by the sheet package unit in a case where the judging unit determines that the replenishment is executed by the sheet package unit.

5. The printing apparatus according to claim 1, further comprising:
a managing unit configured to manage a remaining amount of removed sheets by associated with sheet information for identifying the sheet at the time of replenishing a new type sheet; and
a printing unit configured to print the remaining amount of the sheets associated with the sheet information.

6. The printing apparatus according to claim 5, further comprising:
a selecting unit configured to select a sheet to be exchanged from the sheet information managed by the managing unit; and
an updating unit configured to update a remaining amount of sheets in the sheet storage unit to be replenished with the selected sheet based on the sheet information selected by the selecting unit.

7. The printing apparatus according to claim 1, wherein the sheet storage unit is a paper deck.

8. The printing apparatus according to claim 7, further comprising a plurality of paper decks.

9. A method for controlling a printing apparatus, the method comprising:
receiving a type of a sheet stored in a sheet storage unit;
determining a number of sheet packages to be replenished in the sheet storage unit according to the received type of the sheet in a case where the received type of the sheet is different from a type of a sheet already stored in the sheet storage unit; and
displaying the determined number of sheet packages.

10. A computer readable storage medium for storing a computer program for controlling a printing apparatus, the computer program comprising:
a code to receive a type of a sheet stored in a sheet storage unit;
a code to determine a number of sheet packages to be replenished in the sheet storage unit according to the received type of the sheet in a case where the received type of the sheet is different from a type of a sheet already stored in the sheet storage unit; and
a code to display the determined number of sheet packages.
